(19) United States
(12) Patent Application Publication
(10) Pub. No.: US 2006/0255021 A1
(43) Pub. Date: Nov. 16, 2006

(54) Manufacturing method of slider

(75) Inventor: Ryuta Murakoshi, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K) Ltd., Hong Kong (CN)

(21) Appl. No.: 11/389,533

(22) Filed: Mar. 27, 2006

(30) Foreign Application Priority Data
Mar. 28, 2005 (JP) 2005-091677

(51) Int. Cl. B23K 26/38

(52) U.S. Cl. 219/121.69

(57) ABSTRACT

The invention provides a slider manufacturing method, which includes a cutting step of cutting a row bar constituted with an array of slider element into individual sliders so as to forming a plurality of burrs around a cutting surface of the slider; and a radiating step of radiating electromagnetic wave to the cutting surface of each individual slider, so as to reduce height of burrs extending from an air bearing surface of the individual slider. In the invention, the burrs on the slider formed at row bar cutting process can be removed easily by simple means.

### FIELD OF THE INVENTION

The invention relates to a method of manufacturing slider(s) in a hard disk drive, and more particularly to a method of eliminating burrs formed on cutting surfaces of the slider.

### BACKGROUND OF THE INVENTION

As a recording media of high speed, sufficient capacity, strong reliability and low cost, disk drives are widely used for digital information recording. The disk drive has a slider that incorporates at least one of a recording element for writing information to the recording media and a reading element for reading information therefrom. A read/write portion having the writing element or reading element is disposed at one end of the slider. A surface of the slider that faces the recording medium surface is referred as an air bearing surface (ABS).

Airflow is generated between the slider and recording medium rotating at high speed, when the slider performs information reading/writing operation to the recording medium. The slider is floated slightly above the recording medium by the airflow, when the distance between the ABS and recording medium surface is called flying height. The bit length of the recording medium will be shortened if the flying height reduces, therefore, decreasing of the flying height benefits density improvement of the recording medium. For this purpose, it is required to reduce the flying height more critically according to demand of higher density of disk drive.

A method for manufacturing this type of the slider is described in conjunction with FIGS. 14A˜14F. Firstly, as shown in FIG. 14A, a plurality of slider elements 13 is formed on a wafer 11. Then, the wafer 11 with the plurality of the slider elements 13 formed thereon is sliced into pluralities of bar-shaped row bars 12 using a grinding tool 26. The row bar 12 is cut away along cutting surfaces T1, T2. This state is shown in FIG. 14B. Next, as shown in FIG. 14C, separated row bar 12 is ground along the cutting surface T2 by a special grinding device and ABS is formed which faces the recording medium. The figure shows a perspective view of the row bar 12 viewed from a different direction from that shown in FIG. 14B. After that, as shown in FIG. 14D, the row bar 12 is diced into individual sliders 1 along cutting lines 14 by a grinding tool 27.

However, during process of cutting the wafer into row bars or cutting the row bar into sliders, press stress is generated in the slider-cutting surface due to machining stress formed in cutting process, thus forming burrs on the cutting surface. When cutting the wafer into row bars, as shown in FIGS. 14B, 14C, burrs C11, C12 are formed on both ends of the cutting surfaces T1, T2 (burrs formed on one ends of the T1, T2 are not shown). As shown in FIG. 14D which illustrates an enlarged schematic view of a slider, during process of cutting a row bar into sliders, burrs C2 are formed on edges A1, A2 along a cutting surface S2. The same burrs C3 are formed on edges B1, B2 along the cutting surface S2. Furthermore, the same burrs C2, C3 are also formed on and near a cutting surface S3.

FIGS. 14E-14F illustrate sectional views along X-X line and Y-Y line of FIG. 14D respectively. The burrs C2 are extruded from the ABS, and the burrs C2 are also formed on the opposite surface S5 of the ABS. The burrs C3 are extruded from surfaces S3, S4 which are perpendicular to the ABS.

In ABS forming process, the cutting surface T2 is ground to remove a depth of 50˜80 μm, therefore, the burrs C12 are removed from one side adjacent the cutting surface T2. The burrs C11 formed one side adjacent the cutting surface T1 will not have influence on the cutting surface T1 even if residues are still remained on the side. The burrs C3 are extruded from the surfaces S3, S4. However, as the surfaces S3, S4 are not needed to be very flat, the function thereof will not be affected even if residual burrs C3 are still remained thereon. As for the burrs C2, since they are extruded from the ABS, they have a great influence on decreasing of the flying height, as well as density improvement of the recording medium. Also, the burrs C2 formed on the opposite surface of the ABS may influence a connection with a flexure.

Accordingly, a technology for preventing these residual burrs is disclosed (refer to patent reference 1), in which besides cutting surfaces being ground, the slider is provided with pre-grooves thereon along which the slider is cut off, thus preventing the burrs protruding from the ABS.

Patent reference 1: Japanese Patent Application Publication NO. 2001-143233;

Patent reference 2: Japanese Patent Application Publication NO. H6-84312;

Patent reference 3: Japanese Patent Application Publication NO. H11-328643;

However, some problems exist in technology documented in patent reference 1. First of all, in technology documented in patent reference 1, the burrs themselves are remained in the pre-grooves but not eliminated; therefore universal application in shape design of the ABS has certain limitation. That is, rails that control flying height of the slider when in operation are formed on the ABS; but if residual burrs are remained thereon, it will be difficult to reduce the height of the rails.

Secondly, formation of the pre-grooves at side surfaces of the slider causes substantial increase in width of the cutting portion. In recent years, with miniaturization of disk drive devices to be incorporated in mobile phones, sliders become 30% (slider of 1.0 mm×1.235 mm×0.3 mm) to 20% (slider of 0.7 mm×0.85 mm×0.23 mm) size of traditional sliders, and even smaller sliders are in research. The higher the extent to which the sliders are miniaturized is, the bigger the area occupied by the cutting portions in the wafer is. Therefore, width increment of the cutting portion leads to number reduction of the sliders manufactured from a wafer. Thus results in decreasing of production efficiency along with cost increase for a slider. For reducing cutting width, more precision machining is required; however, reduction of the cutting width will be limited if the pre-grooves are formed thereon.

Furthermore, though the burrs can be removed by grinding the cutting surfaces; however, grinding every individual slider makes the production efficiency lowered.

### BRIEF SUMMARY OF THE INVENTION

A main object of the invention is to provide a method for manufacturing sliders, in which burrs formed on the sliders during row bar cutting process to form sliders can be removed easily by simple means.

The slider manufacturing method of the invention comprises a cutting step of cutting a row bar constituted with an array of slider element into individual sliders so as to forming a plurality of burrs around a cutting surface of the slider; and a radiating step of radiating electromagnetic wave to the cutting surface of each individual slider, so as to reduce height of burrs extending from an air bearing surface of the individual slider.

In the present invention, electromagnetic wave is radiated to the cutting surfaces of the slider so as to produce a contraction stress on the burrs, and thus removing the burrs or reduce the height of burrs effectively.

In the radiating step, the electromagnetic wave is preferably radiated to cutting surfaces at both sides of the slider, especially to middle portion of the cutting surface, and preferably not to fringes and burrs of the cutting surface.

In the radiating step, preferably, the electromagnetic wave radiates in an incline angle equal to or more than 15 degrees relative to the cutting surface.

The cutting step includes a step of holding the row bar to a cutting fixture in advance, a cutting step of cutting off the row bar held on the cutting fixture; and the radiating step includes a step of moving the slider of the row bar such that the cutting surface of the slider is not blocked by its adjacent sliders along radiation direction of the electromagnetic wave, and a step of radiating the electromagnetic wave to the cutting surface of the moved individual slider.

Presently, it is preferable that the electromagnetic wave is a laser with a wavelength of 200-3000 nm and has a radiant intensity of 0.4-4.0 mJ/mm².

In the radiating step, the individual slider may also be radiated by the electromagnetic wave in a state of being dipped into a liquid.

Furthermore, the electromagnetic wave radiates the individual slider with a liquid being supplied to the slider simultaneously.

Presently, it is preferable that the electromagnetic wave is a laser with a wavelength of 200-3000 nm and has a radiant intensity of 0.5-6.0 mJ/mm².

As illustrated above, according to the slider manufacturing method of the invention, the burrs formed on the cutting surfaces of the slider can be removed using simple means. Accordingly, a limitation of decreasing a flying height of the slider is thus eliminated.

For the purpose of making the invention easier to understand, several particular embodiments thereof will now be described with reference to the appended drawings in which:

### BRIEF DESCRIPTION OF THE DRAWINGS

FIG. 1 shows a perspective view of a slider related to slider manufacturing method of the invention;

FIG. 2 shows a flowchart illustrating a slider manufacturing method of the invention;

FIG. 3 shows a step of the slider manufacturing method of the invention;

FIG. 4 shows a step of the slider manufacturing method of the invention;

FIG. 5 shows a step of the slider manufacturing method of the invention;

FIG. 6 shows a schematic view illustrating irradiation direction of the laser;

FIG. 7 shows a schematic view illustrating irradiation angle of the laser;

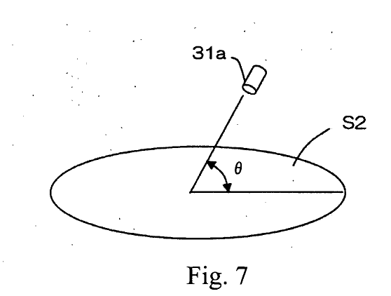

FIG. 8 schematically shows views illustrating effect of the slider manufacturing method of the invention;

FIG. 9 shows a step of the slider manufacturing method of the invention;

FIG. 10 shows cross-sectional views of the ABS illustrating effect of the slider manufacturing method of the invention;

FIG. 11 shows cross-sectional views of the ABS illustrating effect of the slider manufacturing method of the invention;

FIG. 12 shows cross-sectional views of the ABS illustrating effect of the slider manufacturing method of the invention;

FIG. 13 shows cross-sectional views of the ABS illustrating effect of the slider manufacturing method of the invention;

FIG. 14A shows a step of a slider manufacturing method of prior art;

FIG. 14B shows a step of a slider manufacturing method of prior art;

FIG. 14C shows a step of a slider manufacturing method of prior art;

FIG. 14D schematically shows an enlarged view of a individual slider shown in FIG. 14C;

FIG. 14E shows a cross-sectional view along X-X line of FIG. 14D; and

FIG. 14F shows a cross-sectional view along Y-Y line of FIG. 14D.

### DETAILED DESCRIPTION OF THE INVENTION

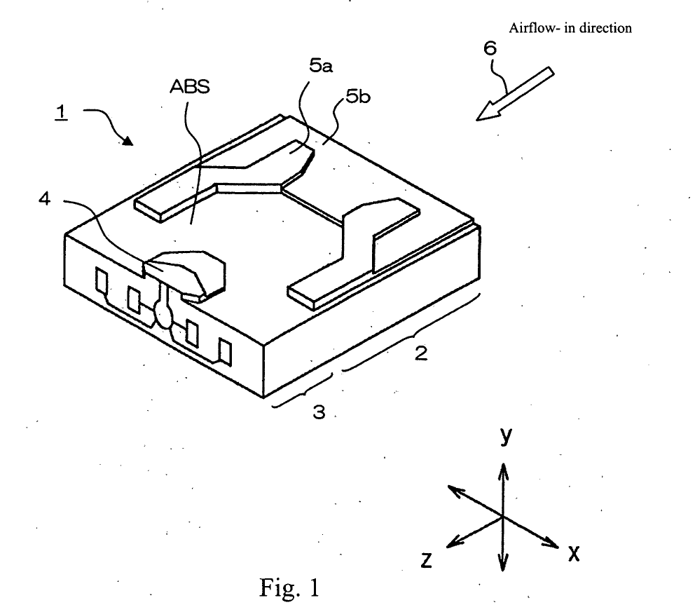

Now, a slider manufacturing method of the invention will be described in detail in conjunction with appendix drawings. FIG. 1 shows a perspective view of a slider related to the slider manufacturing method of the invention. The slider 1 comprises a substrate 2 constructed of ceramic material such as Al₂O₃/TiC and a thin film magnetic head portion 3 formed by a deposition body. A rotary, disk-shaped recording medium (not shown) is disposed above (sometimes under) the slider 1. The slider 1 is approximately a hexahedron shape and one of the six surfaces is formed with an air bearing surface (ABS). A read/write portion 4 incorporating a reading/writing element of the thin film magnetic head portion 3 is formed on the ABS. Rail portions 5a, 5b are also formed on the ABS. Magnetic film element having magneto-resistive effect such as AMR (anisotropic magneto-resistance) element, GMR (giant magneto-resistance) element, or a TMR (tunnel magneto-resistance) element may be used as a reading element. Any magnetic inductive element, for example element using horizontal recording manner in which recording happens in recording medium surface direction, or element using perpendicular recording manner in which recording happens out of recording medium surface direction may be used as a writing element.

When the recording medium rotates, airflow comes in from one side of the slider 1 along air flowing in direction 6 and flows away from back end portion of the slider 1 on which the thin film magnetic head portion 3 is disposed along rotation direction Z of the recording medium. That is, the airflow enters into a gap formed between the rail portion 5b and recording medium, and is commutated by the rail portions 5a and 5b, and then enters into a gap formed between the read/write portion 4 and recording medium. A downward lift force is generated by the airflow along Y direction, and the slider 1 is floated above the recording medium surface.

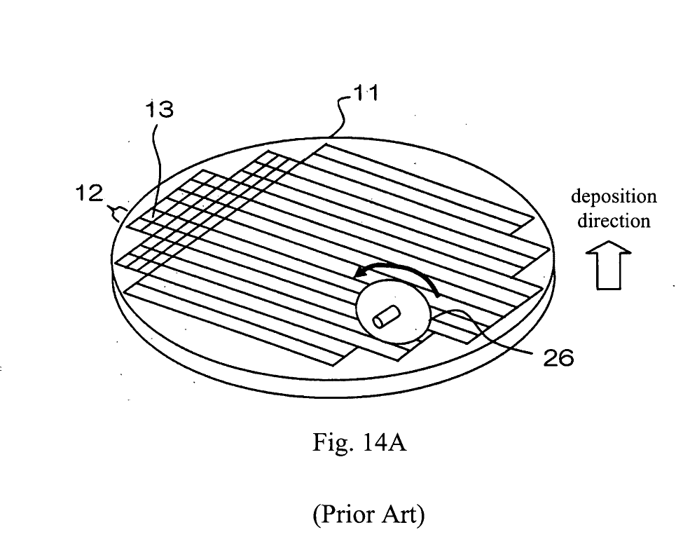

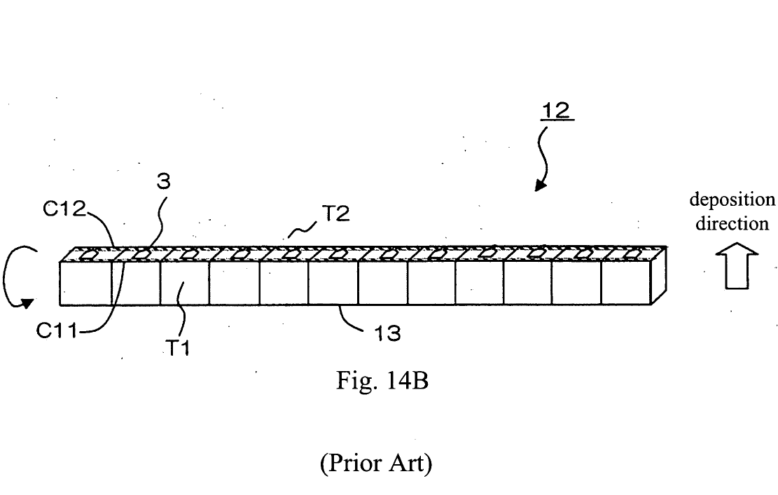

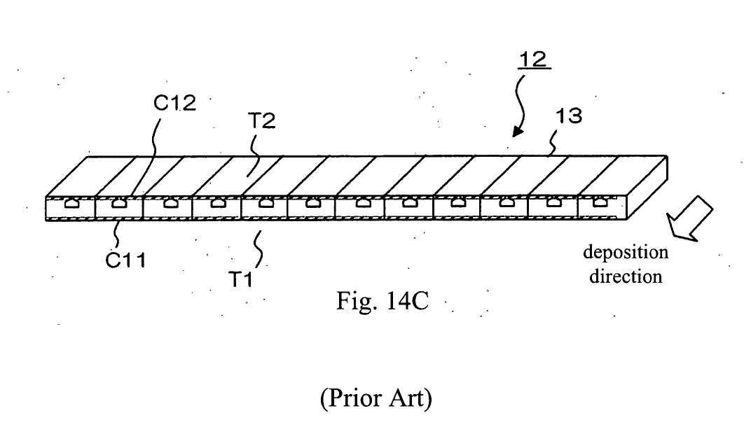

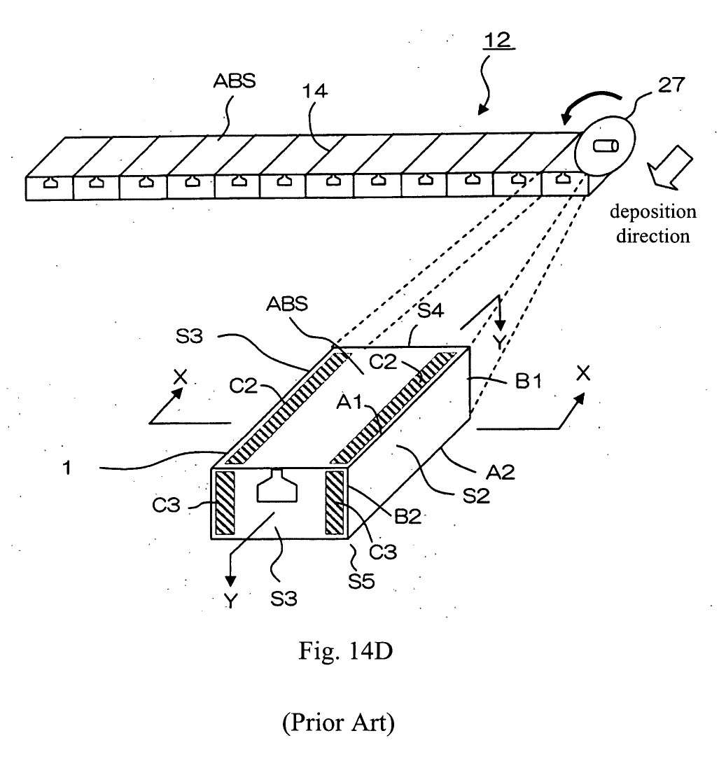

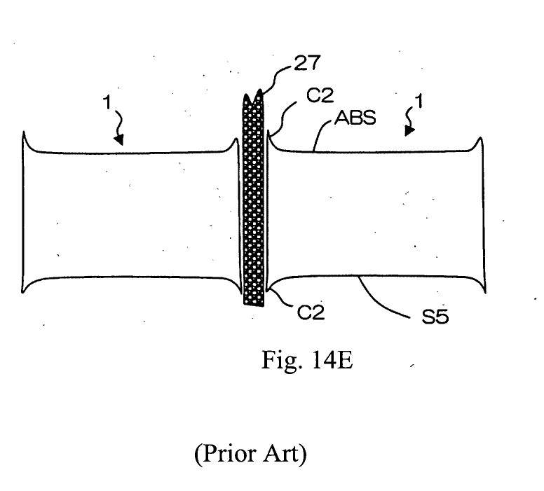

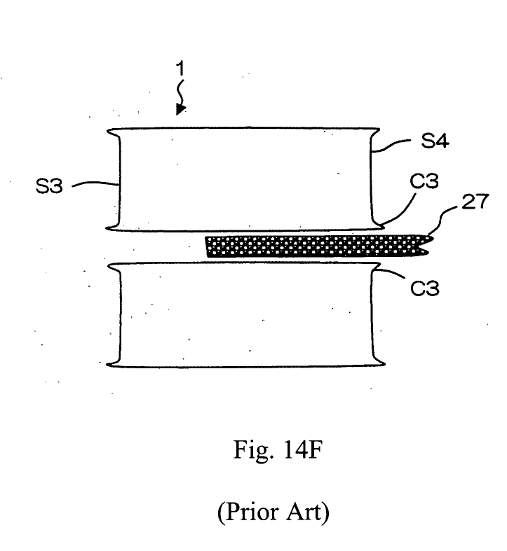

The rail portion 5a is the closest portion of the ABS to the recording medium, while distance between the read/write portion 4 and recording medium is smaller 1˜3 nm than that between the rail portion 5a and recording medium. Height difference between the rail portions 5a and 5b is not necessary. A protective film (not shown) of 1˜4 nm constructed by a compound film consisting of Si and DLC (Diamond Like Carbon) is formed on the ABS. An inner surface S5 (refer to FIG. 14E) of the slider 1 opposing to the ABS is used to contact with the flexure (not shown) that supports the slider 1.

### FIRST EMBODIMENT

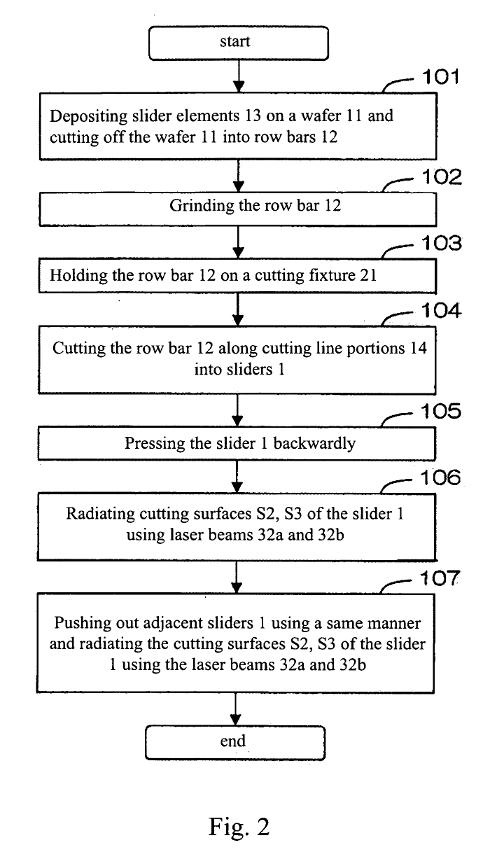

Now, a first embodiment of slider manufacturing method of the invention will be described in conjunction with the flowchart shown in FIG. 2.

(Step 101) firstly, as shown in FIG. 14A, a plurality of slider elements 13 for forming individual sliders 1 are deposited on a wafer 11 by thin film process, and then as shown in FIG. 14B, the wafer 11 is cut into a plurality of bar-shaped row bars 12 along cutting surfaces T2 on each of which the surface to be formed as the ABS is exposed. The plurality of slider elements 13 is arranged on the row bar 12 along length direction thereof. In addition, a test element (not shown) that corresponds with the plurality of the slider elements 13 is preferably disposed on the wafer 11 in advance for controlling grinding volume of the ABS in step 102.

(Step 102) next, the row bar 12 is ground to form determined MR height of the MR element and throat height of the writing element. Furthermore, the rail portions 5a, 5b are formed on the ABS by suitable means such as ion milling.

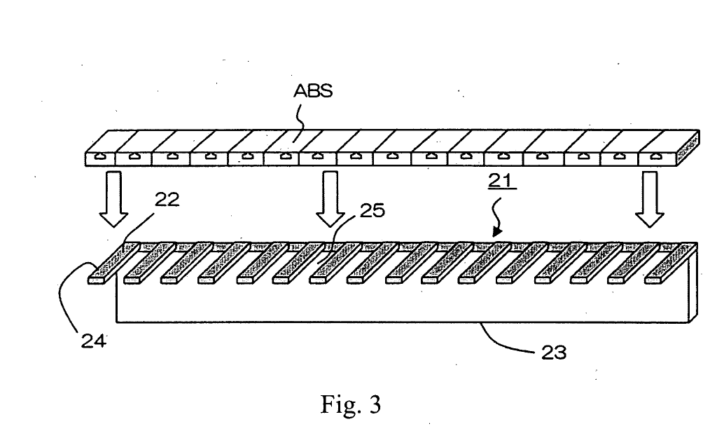

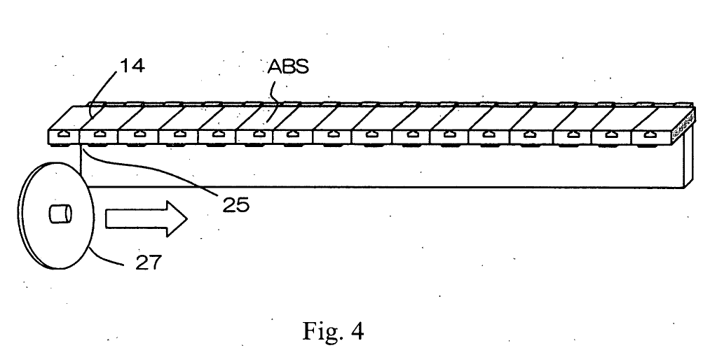

(Step 103) next, the row bar 12 is put on a cutting fixture 21. As shown in FIG. 3, the cutting fixture 21 is constructed by putting an array of slider support portions 22 with gaps 25 formed there between onto a support plate 23. As shown in FIGS. 3, 4, the row bar 12 is secured to securing surfaces 24 of the slider support portions 22 by adhesive with cutting line portions 14 of the row bar 12 being positioned in a manner matching with gaps 25, and the ABS facing up.

(Step 104) next, as shown in FIG. 4, the row bar 12 is cut into sliders 1 along the cutting line portions 14. A grinding stone 27 is used in cutting process. Since the cutting line portions 14 are positioned in a manner matching with the gaps 25 in advance, when the grinding stone 27 runs into the gap 25, it keeps no contact with the cutting fixture 21. Therefore, the row bar 12 is cut off in a state of being supported by the cutting fixture 21. The grinding stone 27 is made of diamond and rotates at a speed of 5000˜20000 rpm. The grinding stone 27 is moved along vector direction shown in figure so as to cut off all sliders 1 gradually; however, the sliders may also be cut off one by one to obtain certain number of the sliders and then steps 104˜106 may be repeated; or a plurality of the sliders may be cut off simultaneously and then steps may be repeated. At this time, burrs C2 as those shown in FIG. 14D, 14E are formed on the cutting surfaces.

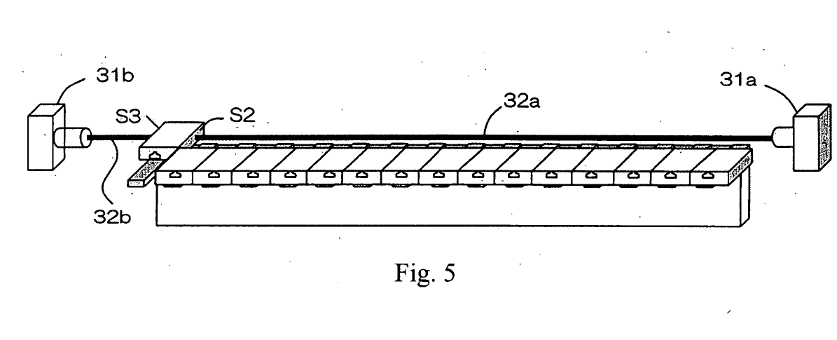

(Step 105) As shown in FIG. 5, the slider 1 closest to left side is pushed backwardly. At a location where the slider 1 is moved, laser irradiators 31a, 31b are disposed at particular positions along normal directions of the cutting surface S2 and cutting surface S3 opposite to the cutting surface S2 respectively. At the location where the slider is moved, laser irradiation of the laser irradiators 31a, 31b towards the cutting surfaces S2, S3 of the individual slider 1 is not blocked by adjacent slider 1 (in addition, the slider 1 closest to left side has no problem of being blocked since no adjacent slider is there).

(Step 106) Laser beams 32a, 32b of the laser irradiators 31a, 31b are irradiated to the cutting surface S2, as well as to the cutting surface S3 of the moved slider 1, as the cutting surface S3 is generated in step 101 when the wafer 11 is cut into row bars 12, thus the cutting surface S3 also having burrs produced thereon.

It is preferable that wavelength of the laser range in 200˜3000 nm. The laser of this range of wavelength is easy to be absorbed by surface of the slider 1 and transformed to heat of high thermal efficiency adjacent the surface of the slider 1. Furthermore, it is preferable that radiant intensity of the laser fall in 0.4˜4.0 mJ/mm². If the radiant intensity is lower than 0.4 mJ/mm², Al2O3/TiC that forms the substrate 2 or aluminum that is main material forming the thin film magnetic head portion 3 will not reach their melting point temperature, therefore sufficient effect will not be achieved. If higher than 4.0 mJ/mm², the slider 1 will generate big thermal deformation. On the basis of the radiation energy, the radiation time is preferably 0.01˜0.1 second, and especially is 0.02 second. The laser beam may be of circle or rectangular shape. When circle laser beam is used, the diameter thereof is preferably 30 μm or larger. If the diameter is smaller than the value, the melted area will be narrower and positions radiated be spotted. Consequently, effect of eliminating burrs substantially will not be achieved, and production efficiency will be degraded extremely. Moreover, generally speaking, the radiation beam is not limited to laser beam, but any electromagnetic wave capable of producing desired energy and achieving same effect may also be used.

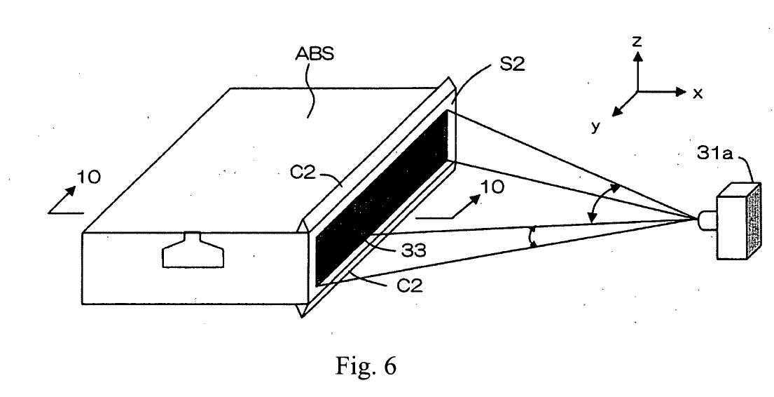

FIG. 6 illustrates irradiation to the cutting surface S2. The laser irradiator 31a sways and scans simultaneously along Y direction of coordinate shown in the same figure, and irradiates vicinity 33 of the burrs C2 of the cutting surface S2. The vicinity 33 is the middle portion of the cutting surface S2, and the burrs C2 themselves or fringes of the cutting surface S2 (fringes A1, A2, B1 and B2 shown in FIG. 14D) are excluded from the irradiation range. That is, the burrs C2 are removed by irradiating and heating the cutting surface S2 using laser, thus changing balance of residual stress produced during cutting process, but not removed by physical manner.

In addition, in concern of surface roughness changes of the ABS and influence on floating characteristics, laser radiation to the ABS is not proposed.

In addition, movement along z direction may also be combined. Moreover, scattered laser beam may also be irradiated to whole surface of the cutting surface S2. The incidence angle □ along which the laser is irradiated to the cutting surface S2 is preferably equal to or more than 15 degrees. If the incidence angle is smaller than 15 degrees, the laser radiated to the cutting surface S2 will be reflected strongly, thus decreasing radiation efficiency. In addition, using the inclined radiation manner, the sliders can be radiated in turn by laser at positions the sliders being cut; even they are not pushed backwardly one by one, hence improving work efficiency.

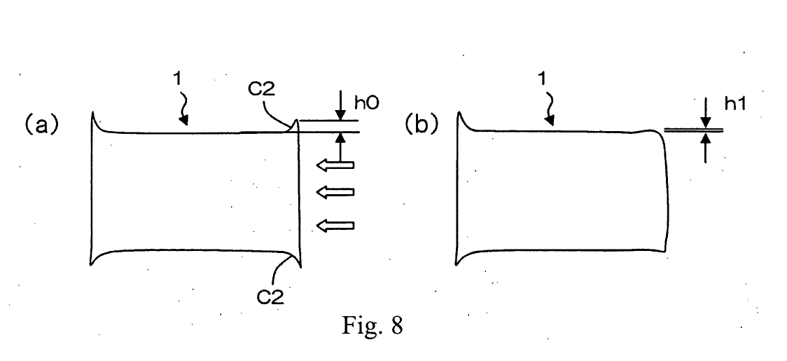

By irradiating of the laser, Al₂O₃/TiC is melted by heat of the laser or recondenses, thus making contraction of the heated portion. Contracting stress is produced underneath the surface irradiated (the cutting surface) due to the contraction. As a result, contracting stress is produced on irradiated portions of the cutting surface S2, thus burrs C2 as shown in FIG. 8(a) is eliminated effectively as that shown in FIG. 8(b). As a purpose of the invention to prevent the burrs from projecting from the ABS of the slider, the height of the burr generated around the cutting surface can be reduced from h0 to h1 (in some cases the height of the burr may also be zero or below completely).

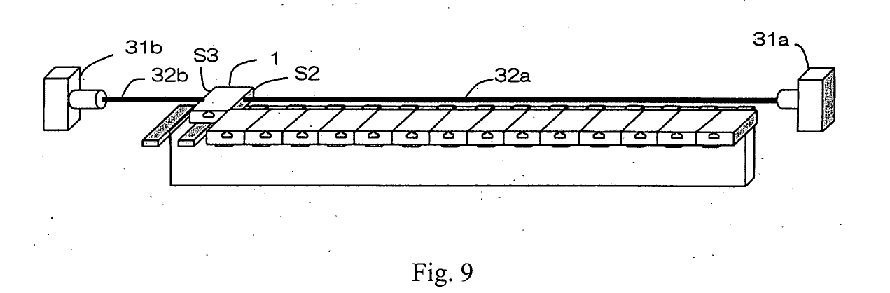

(Step 107) Then, the slider 1 irradiated by the laser and without burrs formed thereon is taken out from the cutting fixture 21 using proper method, and as shown in FIG. 9, adjacent slider 1 is pushed out using a same manner. The cutting surface S3 opposite to the cutting surface S2 of the slider 1 is formed by the grinding stone 27. Therefore, cutting surfaces S2 and S3 at both sides of the slider 1 produce substantially same burrs thereon. After that, as shown in step 106, laser beams 32a, 32b of the laser irradiators 31a, 31b are irradiated to the cutting surface S2, S3 of the slider 1 respectively. All the burrs are removed from the slider 1 by repeating the step.

### EXAMPLE 1

Next, samples are made and effect of the invention is confirmed. In this embodiment, femto-sliders are used and rails are not formed thereon for precisely measuring the ABS. The dimension is as follows: in coordinate shown in FIG. 6, length along X direction is 0.7 mm, length along Y direction is 0.85 mm and length along Z direction is 0.23 mm.

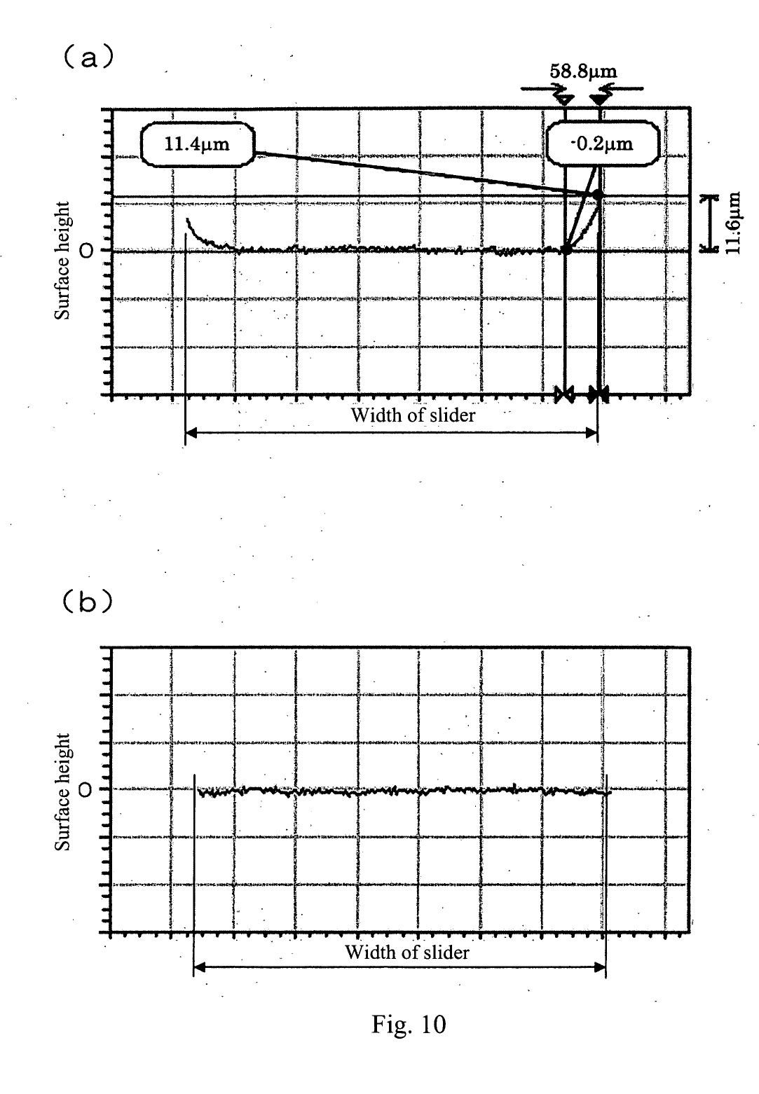

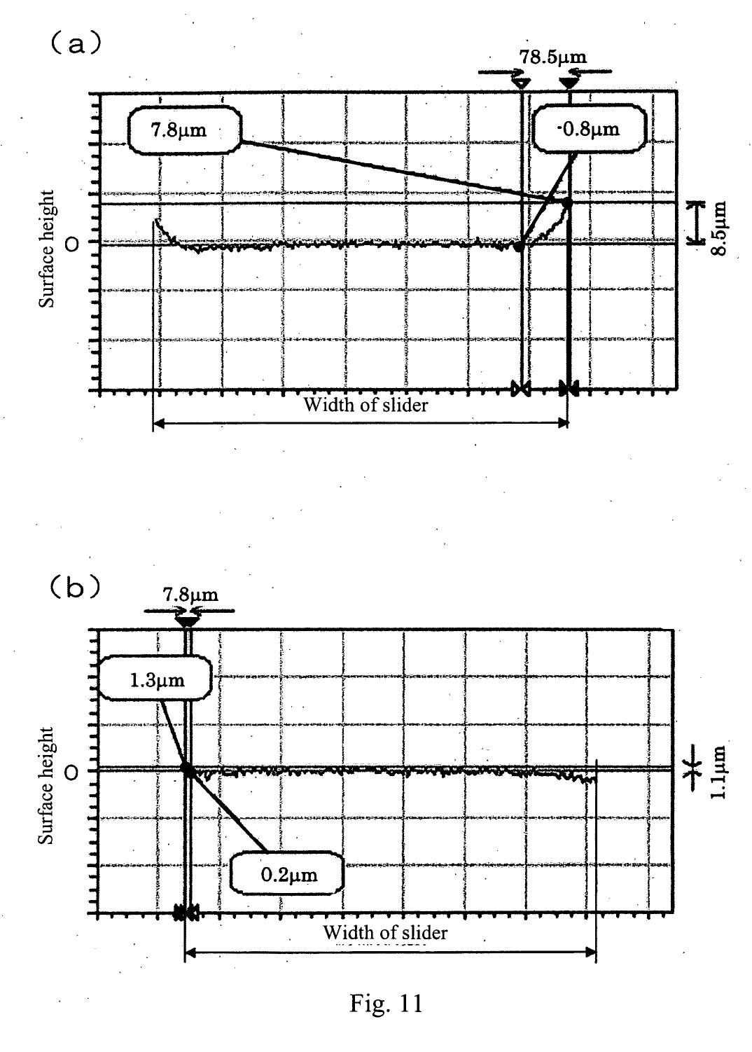

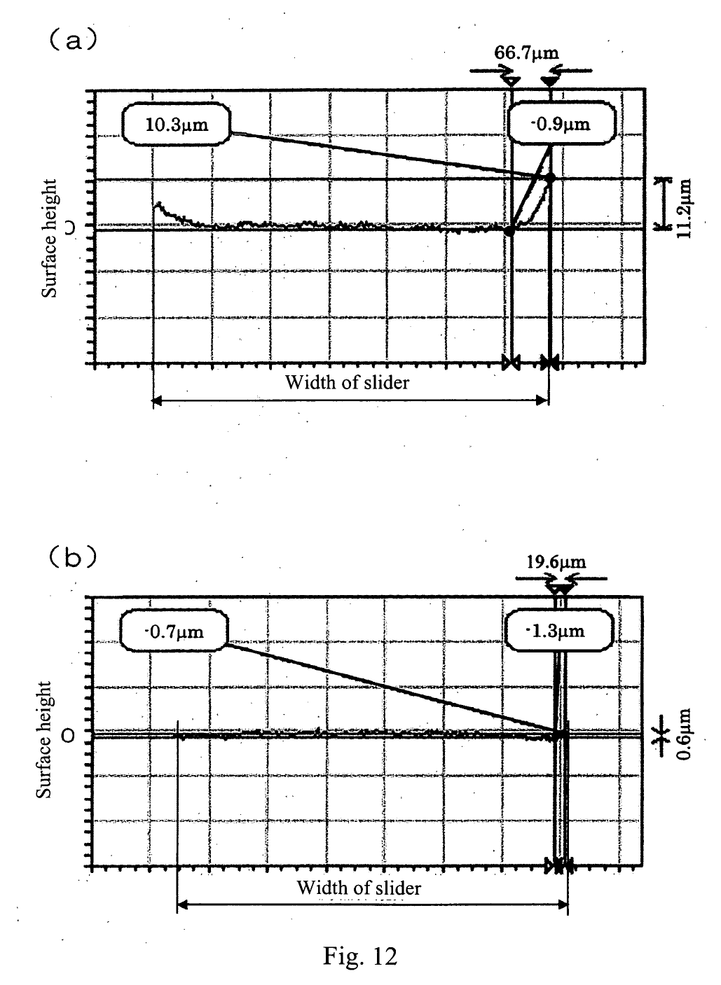

Laser of YAG (Yttriμm-Alμminμm-Garnet) type (wavelength is 1064 nm) is used and radiant intensity is set to 0.5 mJ/mm². FIGS. 10-12 show testing results of the ABS before and after irradiated by three kinds of lasers. In the figures, (a) represents the shape before laser radiation, (b) represents the shape after laser radiation, horizontal axis represents X direction shown in FIG. 6, while vertical axis represents height of the bending along Z direction with respect to the ABS that has a zero height. That is, these figures illustrate cross-sectional views (surface profile of the ABS) along 10-10 line shown in FIG. 6. In the figures, values shown in grids are maximum and minimum height. For example as shown in FIG. 10(a), the maximum height of the burrs is formed at right fringe, and is 11.4 μm, while the minimum height is formed at a left position 58.8 μm far away from the right fringe and is −0.2 μm. Testing position of the direction is different according to different sample; the testing position is approximately at a middle portion of Y direction in FIG. 10, the testing position is at an inner side of Y direction in FIG. 11, while the testing position is at a front side of Y direction in FIG. 12. The three samples have different forming positions in the wafer; however, they are substantially identical product. Here a surface profile detector (product name: WYKO) made by Veeco Company is utilized. As shown in figures, a height of about 10 μm formed by burrs around the slider is formed after cutting the row bar, yet most burrs can be removed by laser radiation.

### SECOND EMBODIMENT

The burr removing method of the first embodiment is preferably performed in air; yet the burrs may also be removed in a state that the individual sliders are dipped into a liquid.

In the method, steps up to step 104 are same as those of the first embodiment. Then, individual sliders are mounted to another fixture in individual or combination manner and dipped into a liquid. When the sliders are cut off and still mounted to the cutting fixture as an entirety, the cutting fixture may be dipped into the liquid, preferably purified water, since laser can pass through the liquid.

Laser radiation manner is the same as that shown in step 106 of the first embodiment. Laser is preferably irradiated to the cutting surfaces at both sides of the slider along normal directions thereof. When dipping each cutting fixture into the liquid, as described in the first embodiment, the laser can irradiate all the sliders if inclined irradiation is taken. Instead of manner of liquid dipping, other manner, such as supply liquid, i.e. spraying liquid to the individual sliders 1 and radiating the sliders 1 using laser at the same time may also attain a same effect.

Preferably, the wavelength of the laser ranges in 200˜3000 nm, and its radiant intensity ranges in 0.5˜6.0 m/mm², and a radiation time is in the range of 0.000001-0.05 seconds. The incidence angle of the laser is the same as that in the first embodiment, and preferably is above 15 degree. Furthermore, same to the first embodiment, the burrs themselves and fringes of the cutting surface are not irradiated.

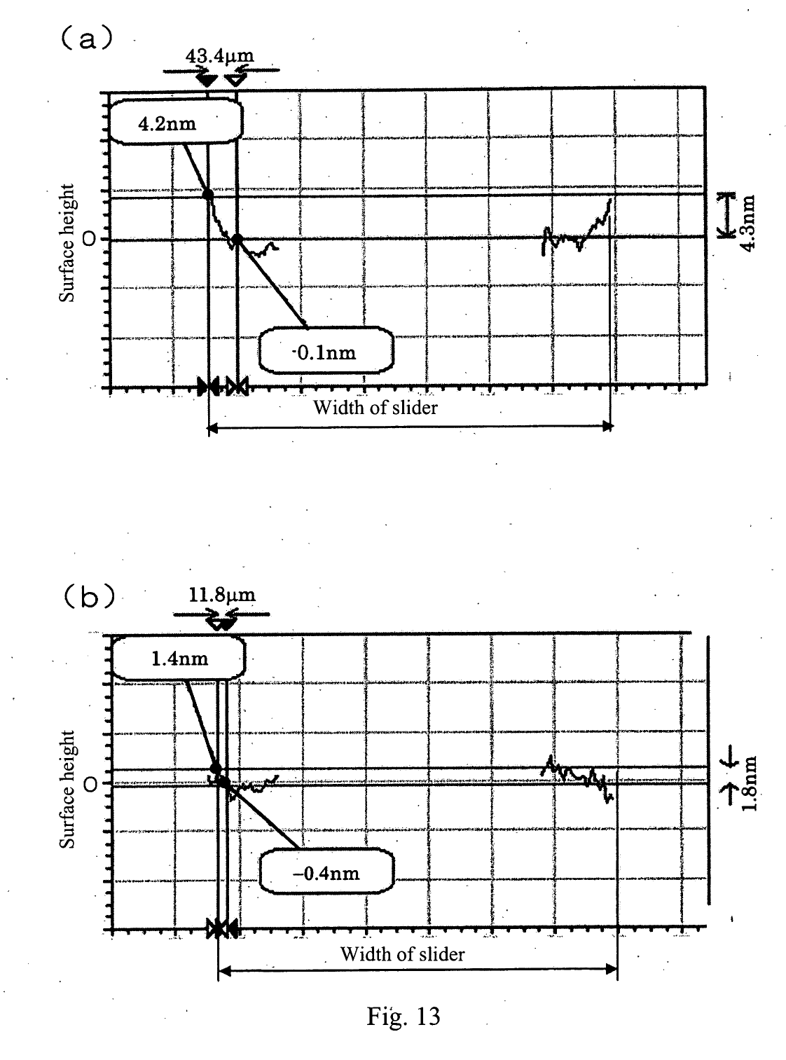

Laser radiation in liquid has an advantage of getting a smooth surface without crack. In other word, laser radiation in air will produce crack on the portion to be radiated. It is believed that the material which is heated and melted is remained on the surface and produces cracks after it is cooled. Comparatively, we believe that when laser radiation happens in the liquid, only outmost surface is heated; therefore, melted material will not remain on the surface, thus no crack being produced. FIG. 13 shows effect of the embodiment, and has the same viewing way and testing condition as those shown in FIGS. 10-12. Also, burr removing effect is confirmed in the embodiment.

Finally, advantages of the invention are summarized. As described above, the invention uses electromagnetic wave irradiation such as laser irradiation to eliminate burrs produced on sliders after the row bar is cut into individual sliders. According to the invention, since burrs themselves can be removed, accordingly, it is unnecessary to consider existence of the burrs in design of slider; hence a limitation of decreasing flying height of the slider is thus eliminated. In addition, more sliders may be readily formed on a wafer, as no pre-groove which widens the cutting width is formed to eliminate burrs. Thus, it is unnecessary to design the slider under consideration of residual burrs, therefore, design freedom of other portions of the ABS, such as rail shape is widened.

The invention has an advantage of improving production efficiency. That is, in the invention, the sliders are positioned and irradiated by laser in air or liquid. Consequently, the method of the invention is easier than removing burrs by grinding in prior art. Also, it is easy to add the process of laser radiation to process of slider separating, thus improving production efficiency. The laser radiator is available easily; therefore the cost of device increases only a little.

What is claimed is:

1. A manufacturing method of slider, comprising:
a cutting step of cutting a row bar constituted with an array of slider element into individual sliders so as to forming a plurality of burrs around a cutting surface of the slider; and
a radiating step of radiating electromagnetic wave to the cutting surface of each individual slider, so as to reduce height of burrs extending from an air bearing surface of the individual slider.

2. The manufacturing method according to claim 1, wherein in the radiating step, the electromagnetic wave is radiated to the cutting surfaces at both sides of the individual slider.

3. The manufacturing method according to claim 2, wherein in the radiating step, fringes and burrs of the cutting surface are not radiated.

4. The manufacturing method according to claim 1, wherein in the radiating step, the electromagnetic wave are radiated in an incline angle equal to or more than 15 degrees relative to the cutting surface of the individual slider.

5. The manufacturing method according to claim 1, wherein
the cutting step comprises:
a step of holding the row bar on a cutting fixture in advance; and a cutting step of cutting off the row bar held on the cutting fixture;
the radiating step comprises:
a step of moving the individual slider on the cutting fixture to make the cutting surface of the individual slider not to be blocked by its adjacent sliders along radiation direction of the electromagnetic wave; and a step of radiating the electromagnetic wave to the cutting surface of the moved individual slider.

6. The manufacturing method according to claim 1, wherein the electromagnetic wave is a laser with a wavelength of 200-3000 nm.

7. The manufacturing method according to claim 6, wherein the radiant intensity of the laser is 0.4-4.0 mJ/mm².

8. The manufacturing method according to claim 1, wherein in the radiating step, the individual slider is radiated by the electromagnetic wave in a state of being dipped into a liquid.

9. The manufacturing method according to claim 1, wherein in the radiating step, the electromagnetic wave radiates the individual slider with a liquid being supplied to the slider simultaneously.

10. The slider manufacturing method according to claim 8, wherein the electromagnetic wave is a laser with a wavelength of 200-3000 nm.

11. The slider manufacturing method according to claim 10, wherein the radiant intensity of the laser is 0.5-6.0 mJ/mm².
